(19) United States
(12) Patent Application Publication
(10) Pub. No.: US 2011/0215912 A1
(43) Pub. Date: Sep. 8, 2011

(54) RFID TAG READER/WRITER

(75) Inventor: Nobuo Murofushi, Shizuoka (JP)

(73) Assignee: TOSHIBA TEC KABUSHIKI KAISHA, Tokyo (JP)

(21) Appl. No.: 13/038,565

(22) Filed: Mar. 2, 2011

(30) Foreign Application Priority Data
Mar. 3, 2010 (JP) 2010-047045

(51) Int. Cl. H04Q 5/22

(52) U.S. Cl. 340/10.51

(57) ABSTRACT

According to one embodiment, an RFID tag reader/writer includes a handle section, an operation input section arranged on the upper part of the handle section to receive an operation input and an antenna section rotatably supported by the handle section such that the antenna section is foldable and unfoldable against the handle section.

### CROSS-REFERENCE TO RELATED APPLICATION

This application is based upon and claims the benefit of priority from the prior Japanese Patent Application No. 2010-047045, filed on Mar. 3, 2010, the entire contents of all of which are incorporated herein by reference.

### FIELD

The disclosure relates generally to a reader/writer, so-called an interrogator, which carries out radio-communications with transponders, such as, e.g., an RFID (Radio Frequency Identification) tag.

### BACKGROUND

A typical RFID tag (transponder) includes an antenna, a radio communication section and a memory section. Unique identification information is stored in the memory section of the tag. When an RFID tag reader/writer (hereinafter referred to as a reader/writer) sends an interrogation signal to the RFID tag, the RFID tag executes a process responding to the interrogation signal from the reader/writer. For example, the RFID tag responds to the interrogation signal only when the identification information stored in the memory is coincident with the identification information contained in the interrogation signal from the reader/writer. Such RFID tag is now widely known.

An RFID tag having such function described above is attachable to variety of articles (commodities) and is used at factories, warehouses and shops. For example, a portable type reader/writer is used when stocktaking is carried out on articles that are placed on the display shelf such that the reader/writer reads out respective identification information of the RFID tags attached to the articles.

In an apparel shop, RFID tags are respectively attached to articles, e.g., clothes, shirts, etc., and the articles are generally displayed in a stacked manner. In particular, if clothes to be displayed are thin, RFID tags attached to the clothes may be densely located. In case that reading is carried out on such RFID tags densely located, it may occur that RFID tags whose identification information can not be read out exist.

A passive-type RFID tag has no battery and thus is energized by an electromagnetic wave transmitted from the reader/writer to carry out radio-communications with the reader/writer. Therefore it is required to receive by the RFID tag an electromagnetic wave having intensity greater than a threshold value at which the RFID tag is energized.

However, in such a state that RFID tags are densely located as described above, attenuation of electromagnetic wave by RFID tags other than the RFID tag subject to communication with the reader/writer may occur. Also, decrease in a receiving efficiency of the RFID tag subject to communication with the reader/writer may occur because of impedance change of the antenna of the RFID tag that is affected by other RFID tags. And thus the RFID tag is not energized due to such accidents described above.

### BRIEF DESCRIPTION OF THE DRAWINGS

Aspects of this disclosure will become apparent upon reading the following detailed description and upon reference to the accompanying drawings. The descriptions and the associated drawings are provided to illustrate embodiments of the invention and not limited to the scope of the invention, wherein:

FIG. 1 is a perspective view illustrating a general construction of a reader/writer and usage thereof according to a first embodiment;

FIG. 2 is a side view illustrating the reader/writer that radiates radio wave;

FIG. 3 is a front view illustrating an example of an RFID tag;

FIG. 4 is a view illustrating a system configuration relating to radio-communication between the reader/writer and RFID tags;

FIG. 5 is a view illustrating one state that the antenna of the reader/writer rotates to one side;

FIG. 6 is a view illustrating another state that the antenna of the reader/writer rotates to the other side;

FIG. 7 is a schematic enlarged view illustrating an internal construction of the antenna and a relationship between an operation-input section and the antenna at the location shown in FIG. 6;

FIG. 8 is a schematic view illustrating a relationship between RFID tags and the reader/writer according to the first embodiment;

FIG. 9 is a side view illustrating a reader/writer according to a second embodiment;

FIG. 10 is a schematic view illustrating an operation of the reader/writer according to the second embodiment;

FIG. 11 is a perspective view illustrating the reader/writer according to the second embodiment;

FIG. 12 is a side view illustrating one state of the reader/writer shown in FIG. 11; and

FIG. 13 is a side view illustrating another state of the reader/writer shown in FIG. 11.

### DETAILED DESCRIPTION

Embodiments will now be described in more detail with reference to the accompanying drawings. However, the same numerals are applied to the similar elements in the drawings, and therefore, the detailed descriptions thereof are not repeated.

In general, according to one embodiment, it is to provide an RFID reader/writer which may carry out radio-communications with RFID tags effectively depending on locations of RFID tags. The RFID tag reader/writer may include a handle section, an operation input section arranged on the upper part of the handle section to receive an operation input and an antenna section rotatably supported by the handle section such that the antenna section is foldable and unfoldable against the handle section.

### First Embodiment

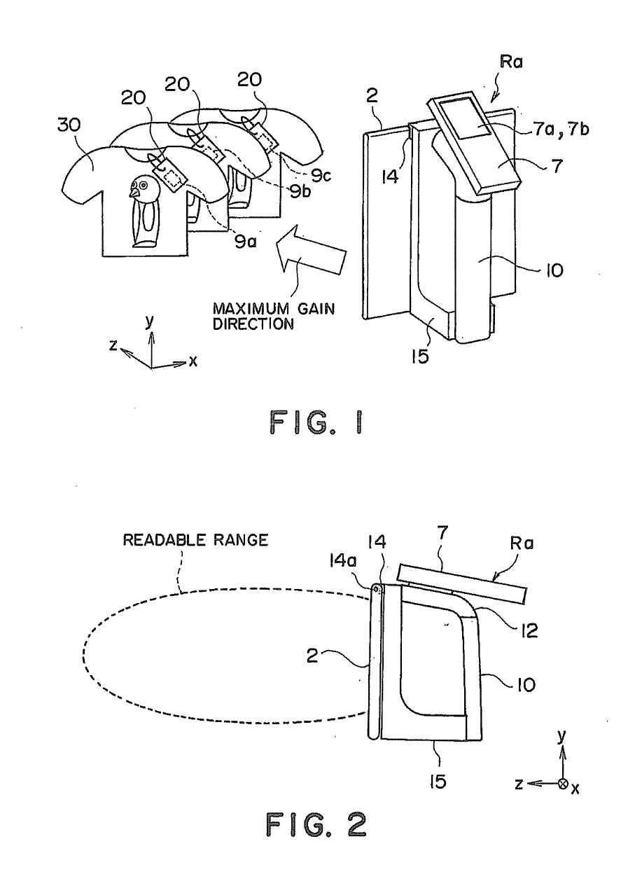

A first embodiment will be described with reference to FIGS. 1 to 8. FIG. 1 is a perspective view illustrating a general construction of an RFID tag reader/writer and usage thereof according to the first embodiment. FIG. 2 is a side view illustrating the RFID tag reader/writer that radiates radio wave.

As shown in FIG. 1, the RFID tag reader/writer (herein after referred to as reader/writer) Ra of the present embodiment executes radio-communications with RFID tags 9a, 9b and 9c respectively fixed on base plates 20 each of which is affixed on article 30, e.g., cloth, which is taken on a hanger at a sales place.

Firstly, a general construction of the reader/writer Ra is described. The reader/writer Ra of the first embodiment includes an antenna 2, a handle 10, an operation input section 7, an upper fixed section 12, a hinge section 14 and a lower fixed section 15.

The antenna 2 is a planer antenna, for example, and is provided with elements such that an earth conductor 2e and a radiation element 2d thereof (shown in FIG. 7) are extended in parallel with the side surface of the housing of the antenna 2 whose area is the largest in the housing (the side surface in parallel with an X-Y plane in FIG. 1). The antenna 2 intensively radiates electromagnetic wave in a direction (a Z-axis direction shown in FIG. 1) orthogonal to the side surface whose area is the largest in the housing and thus a maximum gain direction thereof in the state shown in FIG. 1 is a Z-axis direction, as shown in an arrow. An area indicated by a dotted line in FIG. 2 is a readable area that the reader/writer Ra can read out information of the RFID tag. In other words, it is the area that the reader/writer can radiate a strong radio wave enough to communicate with the RFID tag.

The handle 10 has a shape extending in a Y-axis direction and a user grasps the handle 10 when using the reader/writer Ra.

An upper end portion of the handle 10 is connected to the upper fixed section 12, on the one hand, and a lower end portion thereof is connected to the lower fixed section 15, on the other hand. An end portion at the other side of the upper fixed section 12 that is not connected to the handle 10 and an end portion at the other side of the lower fixed section 15 that is not connected to the handle 10 are connected to one the other at a location higher than the connecting point between the handle 10 and the upper fixed section 12 as shown in FIG. 2. Therefore, a handle section is composed of the handle 10, the upper fixed section 12 and the lower fixed section 15.

The antenna 2 is coupled to the connecting portion between the upper fixed section 12 and the lower fixed section 15 through the hinge section 14. In the state shown in FIG. 1, the antenna 2 is arranged in parallel with the X-Y plane and the handle 10 is arranged to extend along the Y-axis. Thus, the antenna 2 and the handle 10 are in parallel with one the other. The antenna 2 is rotatably supported by a supporting shaft 14a of the hinge section 14, as a rotational axis, so that the antenna is unfolded against the handle section.

The operation input section 7 is arranged above an upper part of the upper fixed section 12 to perform an input operation, a display indication of the operation result by the reader/writer Ra, an audible notification, etc. The operation input section 7 includes a display section 7a and an input section 7b. The display section 7a may be formed with an electronic paper, an LCD (Liquid Crystal Display), or an EL (Electro-luminescence) Display, for example. The input section 7b may be formed with a touch panel, a touch pad, a graphical tablet, or dedicated buttons, for example. Otherwise, the display section and input section may also be integrally constituted as a touch panel display.

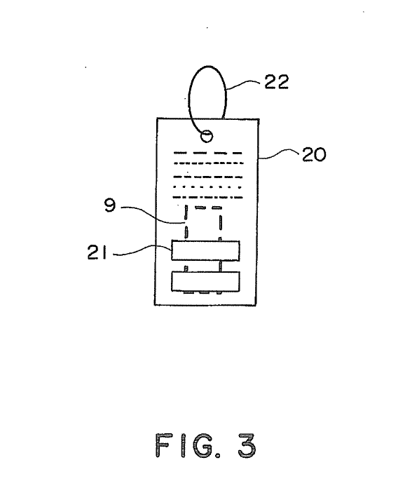

Next, an RFID tag which executes radio-communications with the reader/writer Ra will be described with reference to FIG. 3.

On the based plate 20 attached to an article 30, a bar code 21 whose information relates to the article 30 is printed. An article name and a manufacturer's name may also be printed on the base plate 20. An RFID tag 9 is formed in a thin shape and is embedded on the base plate 20 by sandwiching it between the upper sheet and the lower sheet of the base plate 20. A memory section of the RFID tag 9 stores data corresponding to the information represented by the bar code 21. As shown in FIG. 3, a through hole is formed at the upper part of the base plate 20 and then the base plate 20 with the RFID tag 9 is attached to the article 30 by using a string 22 being passed through the through hole.

The antenna 2 of the reader/writer Ra that has the above-described construction is oriented toward the article 30 and radiates radio wave, as shown in FIG. 1. In this state, radio wave is radiated in a maximum gain direction thereof indicated by an arrow in FIG. 1. Using such reader/writer Ra radiating radio wave described above, stocktaking can be executed.

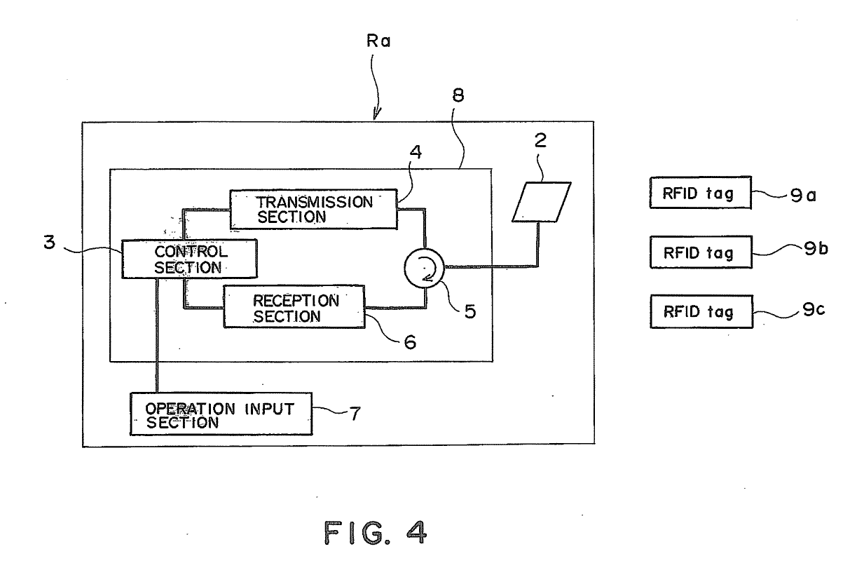

FIG. 4 is a diagram illustrating a system configuration that enables radio-communications between the reader/writer Ra and the RFID tags 9a, 9b, and 9c.

The reader/writer Ra includes the handle section (handle 10), and a control section 3, a transmission section 4, a circulator 5 and a reception section 6 provided in the upper fixed section 12 and the lower fixed section 15. The antenna 2 and the circulator 5 are electrically connected through a coaxial cable, as shown in FIG. 4, such that the coaxial cable passes through the inside of the hinge section 14 to connect the antenna 2 and the circulator 5.

The control section 3 controls the transmission/reception process of the radio wave in the reader/writer Ra and carries out an input/output operation of signals to and from the operation input section 7. The control section 3 further carries out communications with external devices such as, e.g., a personal computer (not shown).

The transmission section 4 is controlled by the control section 3 to modulate data to be transmitted, which is converted to a high frequency signal, and to output the high frequency signal to the circulator 5. Also, the transmission section 4 outputs a non-modulated carrier wave to the circulator 5.

The circulator 5 transmits signals sent from the transmission section 4 to the antenna 2 and vice versa.

The reception section 6 is controlled by the control section 3 to demodulate a high frequency signal input from the circulator 5 and outputs the reception data demodulated to the control section 3.

In the reader/writer Ra of the first embodiment, a transmission/reception section 8 is composed of the control section 3, the transmission section 4, the circulator 5 and the reception section 6. The circulator 5 may be replaced, however, with a directional coupler which performs operation similar to that of the circulator 5.

When the reader/writer Ra transmits a non-modulated carrier wave through the antenna 2, RFID tags 9a, 9b and 9c respectively generate power, using the non-modulated carrier wave and wake up. Following the transmission of the non-modulated carrier wave, the reader/writer Ra transmits an electromagnetic wave modulated with a transmission data (interrogation signal) to RFID tags 9a, 9b and 9c through the antenna 2. In response to the interrogation signal from the reader/writer Ra, RFID tag 9a, 9b or 9c that respectively stores identification information different from one another operates. For example, if the interrogation signal from the reader/writer Ra is an interrogation to one of the RFID tags 9a, only the one of the RFID tags 9a sends a response to the reader/writer Ra and the remaining RFID tags 9b and 9c do not send a response.

Next, a fold/unfold operation of the antenna 2 of the reader/writer Ra will be described according to the first embodiment.

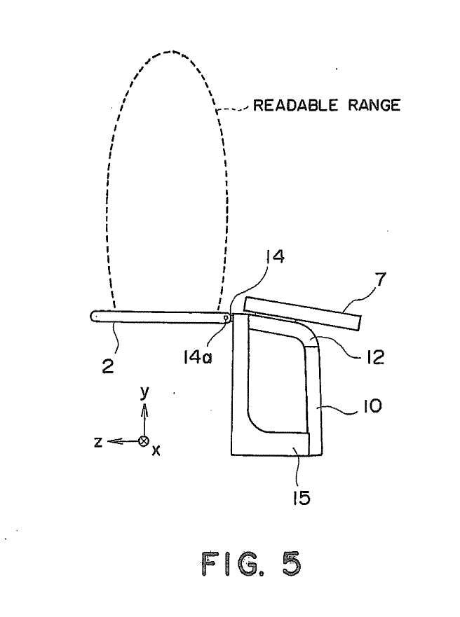

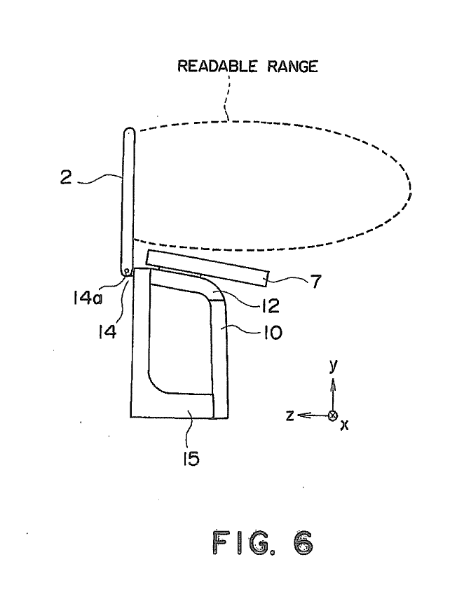

FIGS. 5 and 6 show a movable area of the antenna 2 in case that a single axle rotation hinge is used as the hinge section 14. By the rotation of the antenna 2 against the handle 10 around the hinge section 14, a relationship in a relative angle between the antenna 2 and the handle 10 is changeable.

FIG. 5 is a view illustrating a state that the antenna 2 is rotated around the support axle 14a acting as a support center of the hinge section 14 by 90 degrees from the state shown in FIG. 1. In this state, the antenna 2 has a posture substantially parallel to the X-Z plane. Therefore, radio wave from the antenna 2 is intensively radiated in an upper direction (Y axis direction) in FIG. 5.

FIG. 6 is a view illustrating a state that the antenna 2 is further rotated by 90 degrees around the support axle 14a of the hinge section 14 from the state shown in FIG. 5. In this state, the antenna 2 has a posture substantially parallel to the X-Y plane. Therefore, the radio wave from the antenna 2 is intensively radiated in a right-hand direction (minus direction of the Z axis) in FIG. 5. In other words, a maximum gain direction of radio wave radiated from the antenna 2 is oriented toward a user (reverse direction to that shown in FIG. 2) who holds the reader/writer Ra.

FIG. 7 is a rough construction view illustrating a relationship between the internal construction of the antenna 2 and the operation input section 7 in a state that the antenna 2 is rotated by an angle shown in FIG. 6.

As shown in FIG. 7, according to the reader/writer Ra of the present embodiment, when the antenna 2 is unfolded at the most rotated position against the handle section, at least the lower edge portion of the radiation element 2d shown in FIG. 7 locates at a position higher than the operation input section 7. As shown in FIG. 7, the lower edge portion of the radiation element 2d locates at a location higher than the operation input section 7 by a height (h1) and, in contrast, the lower edge portion of the earth conductor 2e locates at a location lower than the top of the operation input section 7 by a height (h2).

In such a construction as described above, when the antenna 2 is unfolded against the handle section to the most rotated position shown in FIG. 6, the maximum gain direction of radio wave radiated from the radiation element 2d is oriented to a user who holds the handle section and radio wave radiated from the radiation element 2d is not interfere with the operation input section 7. As stated above, because of a state in which no interference of radio wave occurs, a reading to the RFID tag by the reader/writer Ra with a high accuracy can be achieved, even if the antenna 2 is rotated to the state shown in FIG. 6.

Besides, according to the reader/writer Ra of the present embodiment, at least a part of the upper surface of the operation input section 7 is slanted down from the antenna 2 side toward the handle section in a state that a user holds the handle section of the reader/writer Ra (refer to FIG. 2 for example). Therefore, because of the construction that the operation input section 7 is slanted against the antenna 2 which is unfolded, occurrence of interference between the operation input section 7 and radio wave radiated from the antenna 2 can be restrained (refer to FIG. 6).

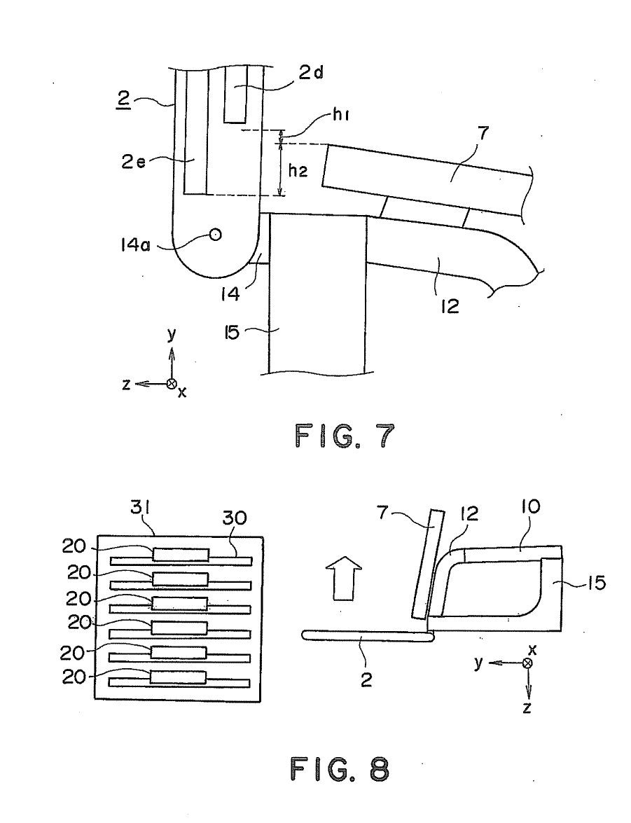

FIG. 8 is a view which is referred to explain the operation of the reader/writer Ra according to the first embodiment. In FIG. 8, a shelf 31 is shown with a sectional view and the reader/writer Ra is shown with a view illustrating a side thereof. As similar to FIG. 1, base plates 20 on each of which RFID tag is mounted are attached to a plurality of articles 30, respectively. Articles 30 are stacked on the shelf 31. The reader/writer Ra is shown in a state that the antenna 2 thereof is unfolded (open state shown in FIG. 6). A user inserts the antenna 2 between the articles 30 stacked on the shelf 31 to read out data of the RFID tags. After inserting the antenna 2 between the articles 30, radio wave is transmitted from the antenna 2 of the reader/writer Ra to receive a response from the RFID tag. Since the antenna 2 intensively radiates an electromagnetic wave in the direction indicated by an arrow shown in FIG. 8, the reader/writer Ra can make a good communication with the RFID tag locating at the upper side of the antenna 2 inserted.

In addition, it can contribute to the solution of the situation that one RFID tag can not start as a result of the attenuation of electromagnetic wave radiated from the antenna 2 by other RFID tags because RFID tags attached to the articles 30 stacked are separated into upper side and lower side by the antenna 2 inserted.

As described above, according to the reader/writer Ra of this embodiment, it can stably read out information of RFID tags densely located with the stacked articles 30 as well as RFID tags attached to the articles 30 taken on the hangers, respectively.

It may be preferable to use a circular polarized plane patch antenna, as antenna 2, if it is difficult to specify orientation of RFID tags to be read.

### Second Embodiment

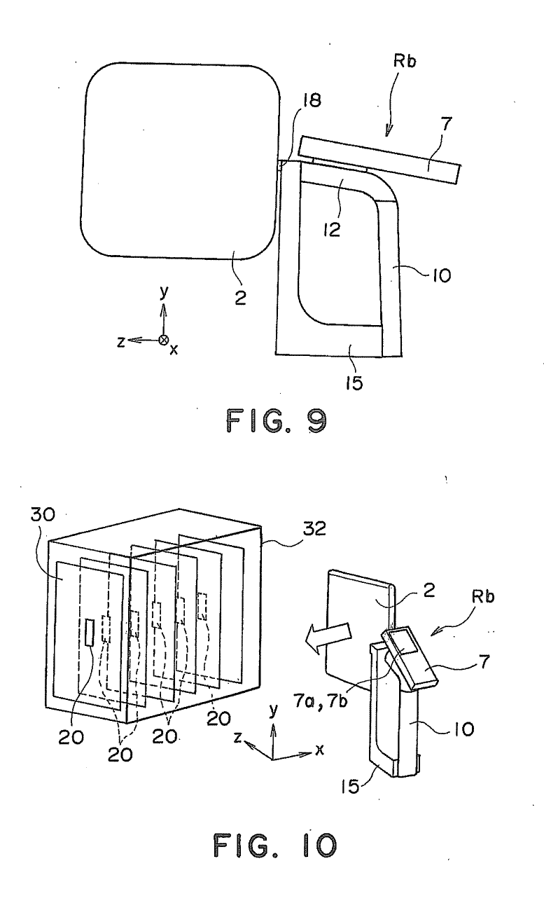

A second embodiment will be described with reference to FIGS. 9, 10 and 11.

The second embodiment is a modification of the first embodiment described above. In this embodiment, the same numerals are applied to the elements having functions similar to that described in the first embodiment, and therefore, detailed explanations thereof are not repeated.

A reader/writer Rb of this embodiment has a specific feature, different from the first embodiment, in which the antenna 2 is rotatably supported by the upper fixed section 12 through a rotary 2-axle hinge.

FIG. 9 is a view illustrating a general construction of the reader/writer Rb of the second embodiment that is seen from the side thereof. In FIG. 9, the antenna 2 is firstly unfolded by 90 degrees from the closed state (folded state) shown in FIG. 1 around a first axle, acting as a rotation center, parallel to the X-axis, and then it is further rotated by 90 degrees around a second axle, acting as a rotation center, parallel to the Z-axis. In the state shown in FIG. 9, the maximum gain direction of radio wave radiated by the antenna 2 is oriented toward a direction perpendicular to the surface of the antenna 2.

It is needless to say that the antenna 2 can take postures shown in FIGS. 1, 5 and 6, respectively when the antenna 2 is unfolded by using the rotary 2-axle hinge 18. That is to say, a radiation direction of radio wave radiated by the antenna 2 of this embodiment can be an opposite direction, as similar to that shown in FIG. 6. In this case, it is preferable that the antenna 2 is located at a position at which the maximum gain direction of radio wave radiated from the radiation element 2d of the antenna 2 is oriented toward a user who holds the handle 10 of the reader/writer Rb and the radio wave radiated from the radiation element 2d does not interfere with the operation input section 7.

FIG. 10 is a view illustrating the operation of the reader/writer Rb according to the second embodiment. In a display shelf 32, a plurality of articles 30 is arranged in parallel with one another in a horizontal direction. Base plates 20 with RFID tags are respectively attached to the plurality of articles 30. A user can perform a reading of data from the RFID tags, inserting the antenna 2 of the reader/writer Rb having a posture shown in FIG. 9 between articles 30 in the display shelf 32.

After inserting the antenna 2 between articles 30, the user operates the reader/writer, which transmits radio wave from the antenna 2 toward RFID tags and receives through the antenna 2 a response signal from each of the RFID tags. Since the antenna 2 intensively radiates radio wave in a direction indicated by an arrow in FIG. 10, RFID tags located at a side indicated by an arrow from the antenna 2 in FIG. 10 can perform a stable communication with the reader/writer Rb through the antenna 2.

In addition, since closely located RFID tags are separated into right-hand side and left-hand side of the antenna 2, it can contribute to the solution of the situation that one RFID tag can not start as a result of the attenuation of electromagnetic wave radiated from the antenna 2 by other RFID tags.

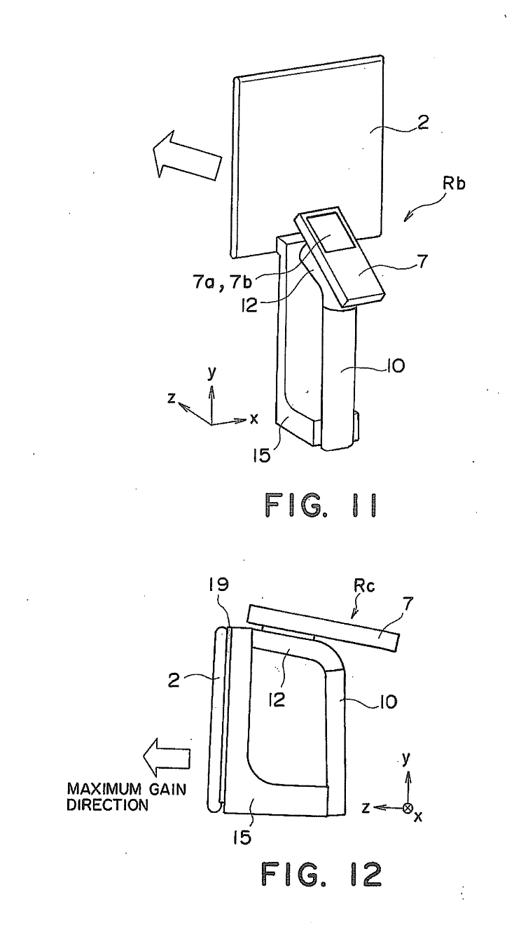

As shown in FIG. 11, since the antenna 2 can be rotated around the axle parallel to the Z-axis on the X-Y plane from the posture shown in FIG. 2, a positional relationship between the antenna 2 and the handle 10 can be altered without changing the maximum gain direction of radio wave radiated from the antenna 2. By rotating the antenna 2 as described above, the antenna 2 extends from the reader/writer Rb and thus the antenna 2 can easily be inserted between the articles 30.

Since the antenna 2 can take postures shown in FIGS. 5 and 6, it can read out data with a high accuracy from not only RFID tags attached to the articles taken on the hangers but also RFID tags attached to the articles stacked on the shelf by using only one set of the reader/writer Rb of this embodiment.

### Third Embodiment

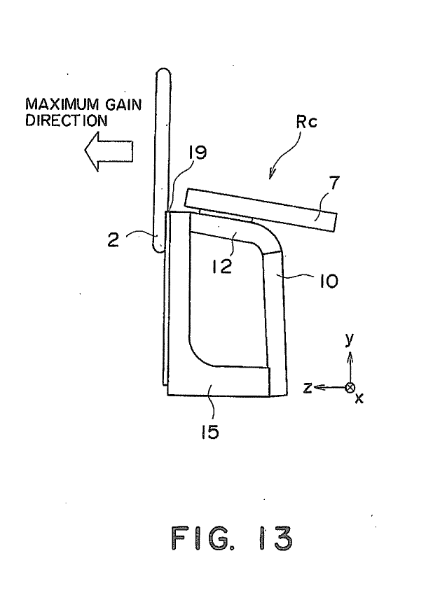

A third embodiment will be described with reference to FIGS. 12 and 13.

The third embodiment is a further modification of the first and second embodiments. In this embodiment, the same numerals are applied to the elements having functions similar to that described in the first and second embodiments, and therefore, detailed explanations thereof are not repeated.

The antenna 2 of the reader/writer Rc according to the third embodiment is supported by a guide 19 shown in FIG. 12 and is linearly slidable relative to the upper fixed section 12. Thus, the antenna 2 moves along the handle 10 between an open position, shown in FIG. 13, at which the antenna 2 projects upward from the handle 10 and a closed position, shown in FIG. 12, at which the antenna 2 does not project from the handle 10.

As shown in FIGS. 12 and 13, the maximum gain direction of radio wave radiated from the antenna 2 of the reader/writer Rc is not changed even if the antenna 2 moves between the closed position and the open position.

Also, as shown in FIG. 13, a relative positional relationship of the antenna 2 against the handle 10 can be changed without changing the maximum gain direction of radio wave radiated from the antenna 2 when the antenna 2 moves upward from the closed position in the Y-axis direction. Since, as described above, the antenna 2 projects from the reader/writer Rc as shown in FIG. 13, the antenna 2 can easily be inserted between the articles.

Since the antenna 2 can take postures shown in FIGS. 12 and 13, it can read out data with a high accuracy from not only RFID tags attached to the articles taken on the hangers but also RFID tags attached to the articles stacked on the shelf by using only one set of the reader/writer Rc of this embodiment.

The present invention has been described with respect to specific embodiments. However, these embodiments have been presented by way of example only, and are not intended to limit the scope of the present invention. Other embodiments based on the principles of the present invention should be obvious those of ordinary skill in the art. Such embodiments are intended to be covered by the claims.

What is claimed is:

1. An RFID tag reader/writer comprising:
a handle section;
an operation input section arranged on the upper part of the handle section to receive an operation input; and
an antenna section rotatably supported by the handle section such that the antenna section is foldable and unfoldable against the handle section.

2. The reader/writer according to claim 1, wherein the antenna section includes a planer antenna composed of a radiation element and an earth conductor, the maximum gain direction of radio wave radiated from the radiation element being oriented toward the handle section side and the radiation element being arranged at a position in the antenna section that radio wave radiated from the radiation element does not interfere with the operation input section in a state that the antenna section is unfolded to a maximum open position.

3. The reader/writer according to claim 2, wherein the radiation element of the antenna section includes a lower edge portion which does not overlap with the operation input section in the state that the antenna is unfolded to the maximum open position.

4. The reader/writer according to claim 2, wherein the operation input section includes a display section and an input section arranged on an upper surface of the operation input section slanted downward from the antenna section side.

5. The reader/writer according to claim 1, wherein the antenna section is rotatably supported by the handle section through a rotary 2-axle hinge.

6. The reader/writer according to claim 1, wherein the operation input section includes a display section and an input section arranged on an upper surface of the operation input section slanted downward from the antenna section side.

7. An RFID tag reader/writer comprising:
a handle section;
an operation input section arranged on the upper part of the handle section to receive an operation input; and
an antenna section including a radiation element and an earth conductor, the antenna section being slidable along the handle section between a first position at which the antenna section projects upward from the handle section and a second position at which the antenna section does not project from the handle section.

8. The reader/writer according to claim 7, wherein the operation input section includes a display section and an input section arranged on an upper surface of the operation input section slanted downward from the antenna section side.
